(19) United States
(12) Patent Application Publication
(10) Pub. No.: US 2014/0313004 A1
(43) Pub. Date: Oct. 23, 2014

(54) MAGNETIC COMPONENT AND TRANSFORMER MADE THEREFROM

(71) Applicant: Enphase Energy, Inc., Petaluma, CA (US)

(72) Inventor: Michael Harrison, Petaluma, CA (US)

(73) Assignee: Enphase Energy, Inc., Petaluma, CA (US)

(21) Appl. No.: 14/259,761

(22) Filed: Apr. 23, 2014

Related U.S. Application Data
(60) Provisional application No. 61/815,096, filed on Apr. 23, 2013.
(60) Provisional application No. 61/920,100, filed on Dec. 23, 2013.

(51) Int. Cl. H01F 27/24

(52) U.S. Cl. CPC H01F 27/24
USPC 336/178

(57) ABSTRACT

A magnetic component and transformer made therefrom is provided. The magnetic component includes an outer circular wall including a first gap and a second gap; an inner circular wall including a third gap and a fourth gap; and a cylindrical core. The outer circular wall, the inner circular wall, and the cylindrical core are concentric to one another. The outer circular wall and the inner circular wall are spaced apart to define an outer radial channel. The inner circular wall and the cylindrical core are spaced apart to define an inner radial channel. A transformer is formed by wrapping a first winding about the inner circular wall and a second winding around the cylindrical core.

### CROSS-REFERENCE TO RELATED APPLICATIONS

This application claims priority to U.S. Provisional Patent Application No. 61/815,096 filed on Apr. 23, 2013 and U.S. Provisional Patent Application No. 61/920,100 filed on Dec. 23, 2013, which are incorporated by reference herein in their entirety.

### BACKGROUND OF THE INVENTION

1. Field of the Invention

Embodiments of the present disclosure relate generally to transformers and, in particular, a highly integrated magnetic component for a transformer.

2. Description of the Related Art

Transformers are used in a variety of devices to perform functions such as altering a voltage level, circuit isolation, measuring voltage or current in electrical power systems, and a host of other functions. In order to provide sufficient space for the windings, the winding area of a transformer is generally large as compared to a cross-sectional area of the transformer's core, resulting in a large form-factor. In some instances, the transformer occupies valuable usable space because of the large form factor.

Therefore, there is a need in the art for a space efficient, compact transformer having magnetic components that are small and compact.

### SUMMARY OF THE INVENTION

Embodiments of the present invention generally relate to transformers and a highly integrated magnetic component.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of a transformer formed by stacking two integrated magnetic portions in accordance with an embodiment of the present invention;

FIG. 2 is a side view formed by stacking a first integrated magnetic portion and a second integrated magnetic portion to form a transformer in accordance with an embodiment of the present invention;

FIG. 3 is an illustration from a cross-sectional view of the transformer of FIG. 2 in accordance with an embodiment of the present invention;

FIG. 4 is an isometric illustration of a first integrated magnetic portion and a second integrated magnetic portion of the integrated magnetic component in accordance with an embodiment of the present invention;

FIG. 5 is an isometric illustration of a portion of an integrated magnetic component in accordance with an embodiment of the present invention;

FIG. 6 is an illustration from a top view of the portion of the integrated magnetic component in FIG. 5 in accordance with an embodiment of the present invention;

FIG. 7 is an isometric illustration from a back view of the portion of the integrated magnetic component in FIG. 5 in accordance with an embodiment of the present invention; and

FIG. 8 is an illustration from a top view of a portion of the integrated magnetic component in accordance with an alternative embodiment of the present invention.

### DETAILED DESCRIPTION

Embodiments of the present invention comprise a magnetic component having a unitary magnetic body comprising concentric radial channels. The channels define cores for primary and secondary windings. As will be discussed herein, the channels and respective windings form a compact, space efficient transformer.

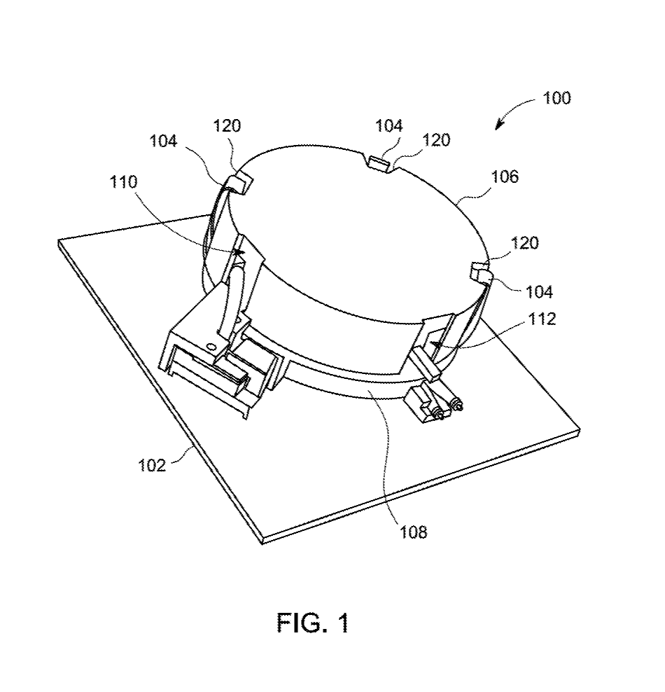

FIG. 1 is an isometric view of a transformer 100 formed by stacking two integrated magnetic portions in accordance with an embodiment of the present invention. The transformer 100 is mounted to a substrate 102.

The transformer 100 comprises a first integrated magnetic portion 106 (i.e., a top magnetic component, hereinafter referred to as first portion 106) and respective windings coupled to a second integrated magnetic portion 108 (i.e., a base magnetic component, hereinafter referred to as second portion 108) and respective windings. A first winding (i.e., a primary coil winding) and a second winding (i.e., a secondary coil winding) exit respective gaps 110 and 112 and are coupled to external circuitry (not shown). A plurality of fastener clips 104 are coupled to a plurality of fastener notches 120 on a backside of the first portion 106. The plurality of fastener clips 104 couple the faces of the first and second portions 106 and 108 together and, in some embodiments, couples to a corresponding fastener notch located on an underside of the second portion 108. In some embodiments, the plurality of fastener clips 104 may instead be coupled to the substrate 102 or other securing base.

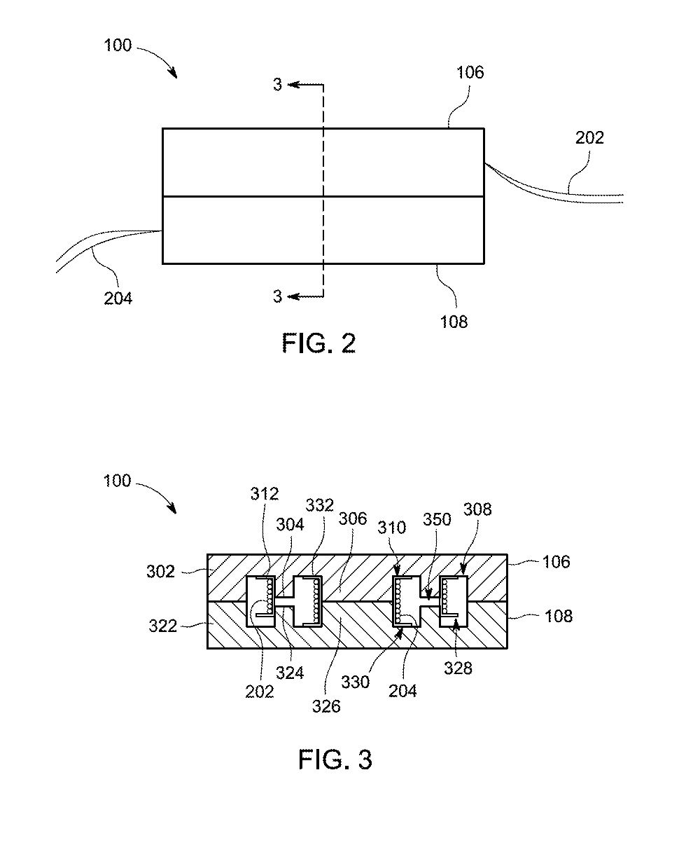

FIG. 2 shows a side view of the transformer 100 in accordance with an embodiment of the present invention. FIG. 3 shows a cross section of the transformer 100 shown in FIG. 2 taken along the line 3-3.

As illustrated in FIGS. 2 and 3, the transformer 100 is formed by coupling the face of the first portion 106 to the face of the second portion 108. The first portion 106 is coupled to the second portion 108 such that an outer circular wall 302 and a cylindrical core 306 of the first portion 106 are in contact with a second outer circular wall 322 and a second cylindrical core 326 of the second portion 108, respectively. An inner circular wall 304 of the first portion 106 and a second inner circular wall 324 of the second portion 108 face one another but are separated by an air gap 350. A first winding bobbin 312 is seated in an outer radial channel 308 of the first portion 106 and extends into a second outer radial channel 328 of the second portion 108. A first coil winding 202 is wrapped around the first winding bobbin 312. A second winding bobbin 332 is seated in a second inner radial channel 330 of the second portion 108 and extends into an inner radial channel 310 of the first portion 106. A second coil winding 204 is wrapped around the second winding bobbin 332. In some embodiments, the second winding bobbin 332 occupies the entirety of the inner radial channel 310 and the second inner radial channel 330 while the first winding bobbin 312 partially extends into the second outer radial channel 328 to allow the second coil winding 204 to pass beneath it and exit the transformer 100, as illustrated in FIG. 3. Although the first portion 106 and the second portion 108 are illustrated as the top and bottom portions, respectively, it should be noted that this orientation may be reversed. Similarly, the first coil winding 202 may be either of the primary or secondary coil winding and the second coil winding 204 may be the other of the primary or secondary coil winding.

In some embodiments, the first coil winding 202 may comprise a copper trace on a substrate (e.g., polyamide, fiberglass, FR4, etc.) and the second coil winding 204 may comprise copper wire and may be insulated (e.g., such as Litz wire). In some embodiments, the first coil winding 202 may be a single loop and the second coil winding 204 may be a plurality (e.g., 8) of loops. However, it should be noted that the first and second coil windings 202, 204 may be formed of any conductive material and may include any number of loops sufficient to perform the functionality of the present invention. The bobbins 312, 332 are typically cylindrical and may include upper and lower flanges. The diameter of the bobbins 312, 332 are substantially are substantially equal to the diameters of their respective channels and in some embodiments comprise a plastic or other non-conductive material. The bobbins 312, 332 are press fit around their respective cores to ensure that they remain in place. Alternatively, in some embodiments, an adhesive may be used to ensure that the bobbins 312, 332 remain in place. In the embodiments in which the second winding bobbin 332 occupies the entirety of the inner radial channel 310 and the second inner radial channel 330 and the first winding bobbin 312 partially extends into the second outer radial channel 328, the secondary winding bobbin 332 is held in place by both portions 106, 108 and the first winding bobbin 312 is held in place by the second coil winding 204 that passes beneath first winding bobbin 312 to exit the transformer 100. The first portion 106 and second portion 108 may be formed of ferrite, manganese zinc ceramic, and the like. A cross section of the cores, walls, and channels, are substantially square or rectangular, however alternative embodiments may be rounded.

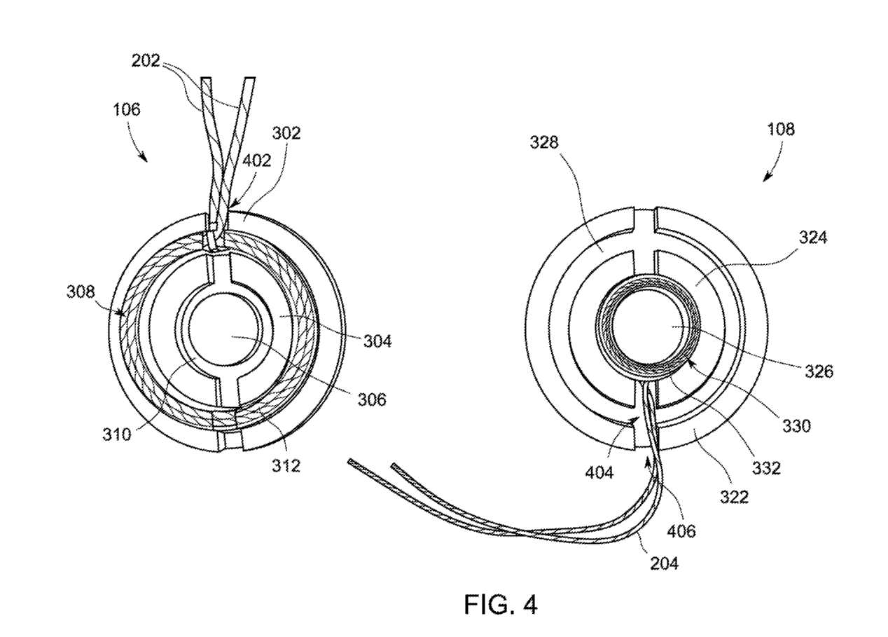

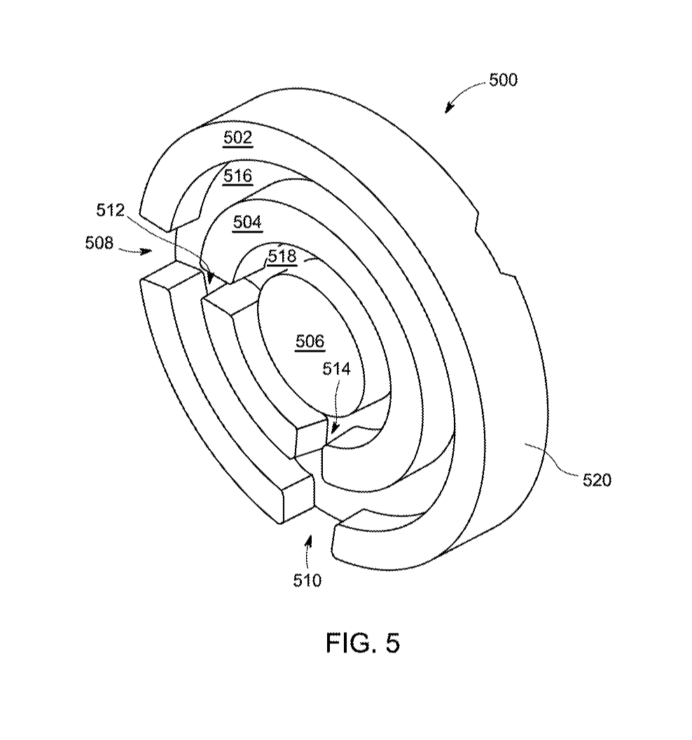

FIG. 4 is an isometric illustration of the first portion 106 and the second portion 108 of the integrated magnetic component in accordance with an embodiment of the present invention. The first portion 106 includes the first coil winding 202 wound around the first winding bobbin 312. The first winding bobbin 312 is seated into the outer radial channel 308. The first winding bobbin 312 is thus located between the outer circular wall 302 and the inner circular wall 304. The ends of the first coil winding 202 are seated and pass through a first gap 402 in the outer circular wall 302.

The second portion 108 includes a substantially symmetrical structure to that of the first portion 106. The second portion 108 includes the second outer circular wall 322, the second inner circular wall 324, and the second cylindrical core 326. The second portion 108 further comprises the second coil winding 204 wound around the second winding bobbin 332. The second winding bobbin 332 is seated in the second inner radial channel 330 located between the second inner circular wall 324 and the second cylindrical core 326. The second outer radial channel 328 is located between the second outer circular wall 322 and the second inner circular wall 324. The ends of the second coil winding 204 pass through a second gap 404 in the second inner circular wall 324 and exit the second portion 108 via a third gap 406 in the second outer circular wall 322.

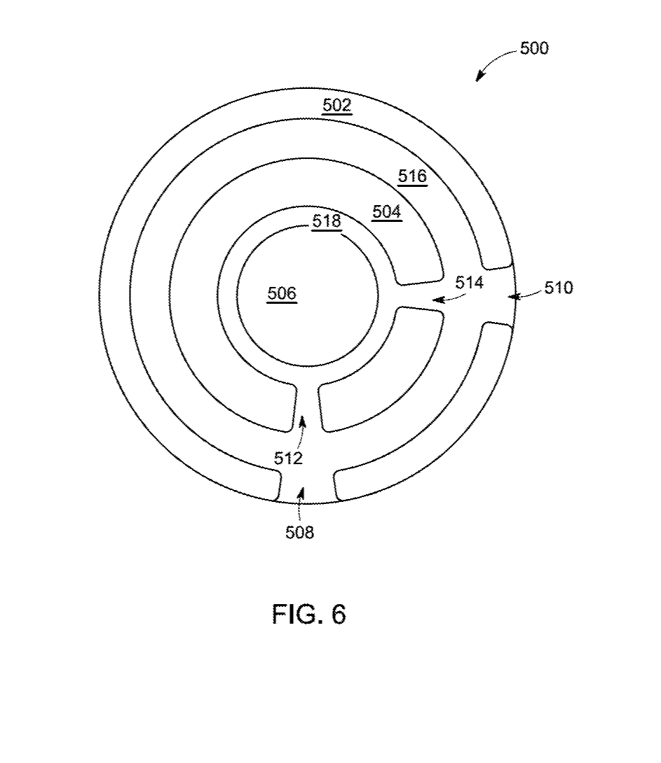

The following description will be made in reference to FIGS. 5 and 6. FIG. 5 is an isometric illustration of a portion 500 of an integrated magnetic component in accordance with an embodiment of the present invention. FIG. 6 is an illustration from a top view of the portion 500 of the integrated magnetic component in FIG. 5. In some embodiments, the portion 500 is substantially circular. However, it should be noted that the portion 500 may have any shape capable of performing the functions disclosed herein. The portion 500 includes an outer wall 502, an inner wall 504 disposed within the outer wall 502, and a cylindrical core 506 disposed within the inner wall 504, all of which extend from a base 520. In some embodiments, the outer wall 502, the inner wall 504, and the cylindrical core 506 are concentric to one another.

The outer wall 502 may include a first gap 508 and a second gap 510. The inner wall 504 may include a third gap 512 and a fourth gap 514 which are aligned with the first and second gaps 508, 510, respectively. The first gap 508 and the second gap 510 are offset by 90 degrees around the center of the cylindrical core 506. In alternative embodiments, the first gap 508 and second gap 510 are offset by a different angle or located on opposite sides of the portion 500 (e.g., FIG. 4). Although the outer wall 502 is illustrated with two gaps 508, 510, it should be noted that the outer wall 502 may include any number of gaps (i.e., one or more) that allows cables within the integrated magnetic component to couple to external circuitry. The first and second gaps 508, 510 couple to an outer radial channel 516 defined between the outer wall 502 and the inner wall 504. The first and second gaps 508, 510 also couple to an inner radial channel 518 defined between the inner wall 504 and the cylindrical core 506 via the third and fourth gaps 512, 514.

The outer walls 502 and cylindrical core 506 may be of substantially the same height so when the portion 500 is stacked onto a second portion, the assembly forms a substantially flush contact between corresponding outer walls and cores to house cabling (not shown). The inner wall 504 may be shorter than the outer wall 502 and the cylindrical core 506 so when the portion 500 is stacked onto the second portion, the assembly forms an air gap between the corresponding inner walls, as previously explained. In some embodiments, the walls may be annular, circular, or comprise a shape with rounded edges.

In some embodiments, a first cabling may be looped around the cylindrical core 506 through the first and third gaps 508 and 512 and a second cabling may be looped around the inner wall 504 (of another portion) through the second gap 510. During assembly, each respective cabling may be looped on opposite facing portions before stacking. Alternatively, cabling may be wrapped around a bobbin (not shown) before stacking. In another embodiment, a first and second cabling may be wrapped around the corresponding cylindrical cores of the respective top and base portions and respectively extend through gap pairs 508/512 and 510/514. The cabling may be a braided cable or twisted wire.

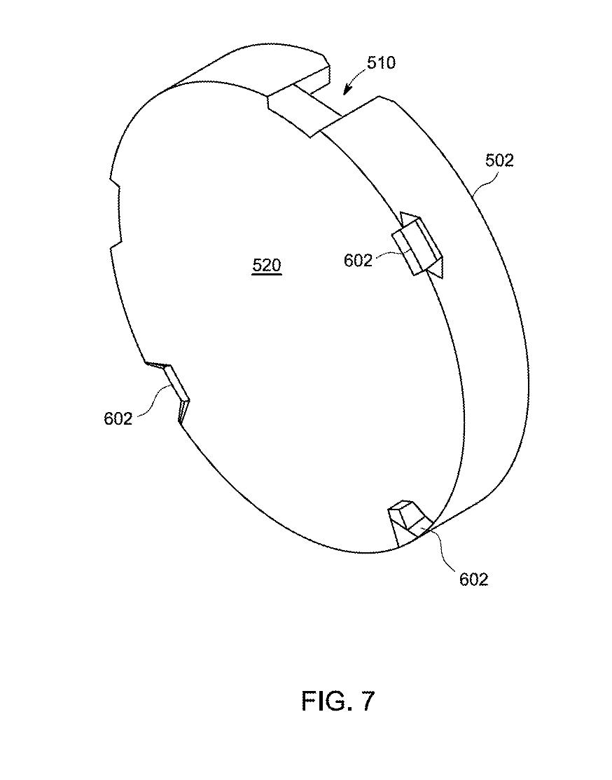

FIG. 7 is an isometric illustration from a back view of the portion 500 of the integrated magnetic component in FIG. 5 in accordance with an embodiment of the present invention. The base 520 may include fastener notches 602 which are used to couple two portions together to form a transformer, as shown in FIG. 1 and described above.

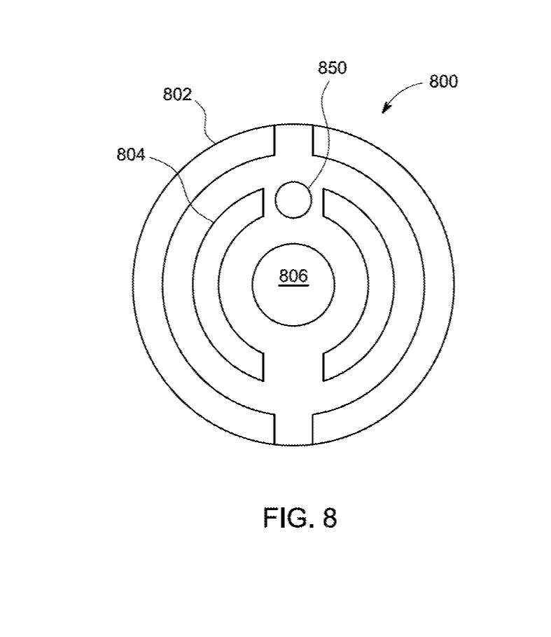

FIG. 8 is an illustration from a top view of an integrated magnetic portion 800 in accordance with an alternative embodiment of the present invention. The portion 800 is substantially similar to the portion 500 of FIG. 5 and includes an outer wall 802, an inner wall 804, and a cylindrical core 806. However, the portion 800 additionally includes a sensor post 850 that replaces one of the inner gaps formed in the inner wall 804. A description of elements of the portion 800 that are similar to those of the portion 500 will be omitted here for the sake of conciseness. The sensor post 850 is of substantially the same height as the outer wall 802 and the cylindrical core 806 so that when the portion 800 is stacked onto another portion, the sensor posts, outer walls, and cylindrical cores of the two portions are in substantially flush contact.

The sensor post 850 forms a core around which a current sensor coil winding (not shown) is wrapped. The wrapping of the current sensor coil winding may be similar to that of the winding of the first and second coil windings 202, 204 described above with respect to FIG. 3. That is, the current sensor coil winding may be wound around a current sensor bobbin, which is seated around the sensor post 850. The ends of the current sensor coil winding pass through the nearest gap in the outer wall 802. The current sensor coil winding may be of a thinner gauge than that of the first and second coil windings 202, 204. With the thinner gauge coil, the current sensor coil winding may exit the portion 800 using the same gap as the first or second coil winding without electrically or mechanically interfering with the first or second coil winding. Sensor circuitry (not shown) is coupled to the sensor coil winding and the sensor circuitry measures the current of the primary winding (i.e., the current sensor winding yields a measurable current that is indicative of the primary current on the winding of the primary coil winding).

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof.

1. A magnetic component, comprising:
an outer circular wall including a first gap and a second gap;
an inner circular wall including a third gap and a fourth gap; and
a cylindrical core,
wherein the outer circular wall, the inner circular wall, and the cylindrical core are concentric to one another,
wherein the outer circular wall and the inner circular wall are spaced apart to define an outer radial channel;
wherein the inner circular wall and the cylindrical core are spaced apart to define an inner radial channel.

2. The magnetic component of claim 1, further comprising:
a first portion including a first outer circular wall, a first inner circular wall, and a first cylindrical core; and
a second portion including a second outer circular wall, a second inner circular wall, and a second cylindrical core,
wherein a first face of the first portion and a second face of the second portion are coupled to each other.

3. The magnetic component of claim 2, further comprising an air gap between the first inner circular wall and the second inner circular wall, wherein the first outer circular wall sits flush against the second outer circular wall, and wherein the first cylindrical core sits flush against the second cylindrical core.

4. The magnetic component of claim 1, further comprising:
a sensor post disposed in one of the third gap or the fourth gap.

5. The magnetic component of claim 1, wherein the first gap is offset from the second gap by 90 degrees around a center of the cylindrical core.

6. The magnetic component of claim 1, wherein the first gap and the second gap are disposed on opposite sides of the magnetic component.

7. A transformer, comprising:
an outer circular wall including a first gap and a second gap;
an inner circular wall including a third gap and a fourth gap;
a cylindrical core;
a first coil winding wrapped around the cylindrical core; and
a second coil winding wrapped around the inner circular wall,
wherein the outer circular wall, the inner circular wall, and the cylindrical core are concentric to one another,
wherein the outer circular wall and the inner circular wall are spaced apart to define an outer radial channel;
wherein the inner circular wall and the cylindrical core are spaced apart to define an inner radial channel.

8. The transformer of claim 7, further comprising:
a first portion including a first outer circular wall, a first inner circular wall, and a first cylindrical core; and
a second portion including a second outer circular wall, a second inner circular wall, and a second cylindrical core,
wherein a first face of the first portion and a second face of the second portion are coupled to each other such that the first outer circular wall sits flush against the second outer circular wall, the first cylindrical core sits flush against the second cylindrical core, and the first inner circular wall is separated from the second inner circular wall by an air gap.

9. The transformer of claim 8, wherein the first coil winding is wrapped around a first winding bobbin that surrounds the cylindrical core and the second coil winding is wrapped around a second winding bobbin that surrounds the inner circular wall.

10. The transformer of claim 9, wherein the first outer circular wall and the first inner circular wall define a first outer radial channel and the second outer circular wall and the second inner circular wall define a second outer radial channel, wherein the first inner circular wall and the first cylindrical core define a first inner radial channel and the second inner circular wall and the second cylindrical core define a second inner radial channel, and wherein the first outer radial channel and the second outer radial channel form the outer radial channel of the transformer and the first inner radial channel and the second inner radial channel form the inner radial channel of the transformer when the first portion is coupled to the second portion.

11. The transformer of claim 10, wherein the first winding bobbin is seated in the first outer radial channel and extends into the second outer radial channel when the first portion is coupled to the second portion, and wherein the second winding bobbin is seated in the second inner radial channel and extends into the first inner radial channel.

12. The transformer of claim 11, wherein the first winding bobbin partially extends into the second outer radial channel and the second winding bobbin occupies an entirety of the inner radial channel of the transformer.

13. The transformer of claim 7, wherein the first gap is offset from the second gap by 90 degrees around a center of the cylindrical core.

14. The transformer of claim 7, wherein the first gap and the second gap are disposed on opposite sides of the transformer.

15. The transformer of claim 7, further comprising:
a sensor post disposed in one of the third gap or the fourth gap of the inner circular wall; and
a current sensor coil winding wrapped around the sensor post.

16. The transformer of claim 15, wherein a thickness the current sensor coil winding is less than respective thicknesses of the first coil winding and the second coil winding.

17. An integrated magnetic component, comprising:
a substrate;
a top magnetic component including a plurality of notches on a backside of the top magnetic component;
a base magnetic component sized and shaped similarly to the top magnetic component, the base magnetic component disposed on the substrate; and
a plurality of fastener clips to couple to the plurality of notches, the plurality of fastener clips coupling the top magnetic component, the base magnetic component, and the substrate together,
the top magnetic component, comprising:
a first outer circular wall including a first gap and a second gap;
a first inner circular wall including a third gap and a fourth gap; and
a first cylindrical core,
wherein the first outer circular wall, the first inner circular wall, and the first cylindrical core are concentric to one another,
wherein the first outer circular wall and the first inner circular wall are spaced apart to define a first outer radial channel, and
wherein the first inner circular wall and the first cylindrical core are spaced apart to define a first inner radial channel; and
the base magnetic component, comprising:
a second outer circular wall including a fifth gap and a sixth gap;
a second inner circular wall including a seventh gap and an eighth gap; and
a second cylindrical core,
wherein the second outer circular wall, the second inner circular wall, and the second cylindrical core are concentric to one another,
wherein the second outer circular wall and the second inner circular wall are spaced apart to define a second outer radial channel, and
wherein the second inner circular wall and the second cylindrical core are spaced apart to define a second inner radial channel,
wherein the top magnetic component and the base magnetic component are physically and magnetically coupled to one another to form a transformer,
wherein, when the top magnetic component is coupled to the base magnetic component, the first outer circular wall is aligned with the second outer circular wall, the first inner circular wall is aligned with the second inner circular wall, the first cylindrical core is aligned with the second cylindrical core, the first outer radial channel is aligned with the second outer radial channel, and the first inner radial channel is aligned with the second inner radial channel,
wherein, when the top magnetic component is coupled to the base magnetic component, the first outer circular wall lies flush against the second outer circular wall and the first cylindrical core lies flush against the second cylindrical core,
wherein, when the top magnetic component is coupled to the base magnetic component, the first inner circular wall and the second inner circular wall are spaced apart by an air gap, and
wherein, when the top magnetic component is coupled to the base magnetic component, the first gap is aligned with the fifth gap, the second gap is aligned with the sixth gap, the third gap is aligned with the seventh gap, and the fourth gap is aligned with the eighth gap.

18. The integrated magnetic component of claim 17, further comprising:
a sensor post disposed in one of the third gap, the fourth gap, the seventh gap, or the eighth gap.

19. The integrated magnetic component of claim 17, wherein the first and fifth gaps are offset from the second and sixth gaps by 90 degrees around a center of the first and second cylindrical cores.

20. The integrated magnetic component of claim 17, wherein the first and fifth gaps are disposed opposite to the second and sixth gaps.
